(19) United States
(12) Patent Application Publication
(10) Pub. No.: US 2020/0039201 A1
(43) Pub. Date: Feb. 6, 2020

(54) VACUUM-ASSISTED TOOLS FOR USE IN PRESSING STACKS OF ONE OR MORE LAMINAE AND RELATED METHODS

(71) Applicant: SABIC Global Technologies B.V., Bergen op Zoom (NL)

(72) Inventor: Theofanis THEOFANOUS, Elsloo (NL)

(21) Appl. No.: 16/498,681

(22) PCT Filed: Mar. 27, 2018
(86) PCT No.: PCT/IB2018/052098

§ 371 Date: Sep. 27, 2019

Related U.S. Application Data
(60) Provisional application No. 62/477,420, filed on Mar. 27, 2017.

(51) Int. Cl. B32B 37/00; B30B 15/06; C09K 3/10; B32B 37/10; B29C 70/44

(52) U.S. Cl. CPC B32B 37/0046; B30B 15/064; C09K 3/1009; B32B 2309/68; B32B 37/0007; B29C 70/44; B32B 37/1009

(57) ABSTRACT

This disclosure includes vacuum-assisted tools (10a) for use in pressing stacks (284) of one or more laminae (288a-288i) and related methods. Some tools include first and second plates (14a-14f), wherein each of the plates has an inner face and an opposing outer face, and the plates are configured to be disposed on opposing sides of a stack of one or more laminae such that the inner faces of the plates face the stack to define an interior volume (18) containing the stack between the inner faces, one or more seals (176, 176a-176e) configured to be disposed between the plates such that the one or more seals surround at least a portion of the interior volume, and a port (224) configured to be coupled to the first plate, the second plate, and/or at least one of the one or more seals, the port configured to permit fluid communication between the portion of the interior volume and a vacuum source (26).

### CROSS-REFERENCE TO RELATED APPLICATIONS

This application claims the benefit of priority of U.S. Provisional Patent Application No. 62/477,420 filed Mar. 27, 2017, which is hereby incorporated by reference in its entirety.

### BACKGROUND

### 1. Field of Invention

The present invention relates generally to composite laminates, and more specifically, to vacuum-assisted tools for use in pressing stacks of one or more laminae (e.g., during heating, cooling, and/or consolidation of the stacks) and related methods.

### 2. Description of Related Art

Composite laminates can be used to form structures having advantageous structural characteristics, such as high stiffnesses and high strengths, as well as relatively low weights, when compared to structures formed from conventional materials. As a result, composite laminates are used in a wide variety of applications across a wide range of industries, including the automotive, aerospace, and consumer electronics industries.

To produce such a laminate, a stack of laminae can be consolidated by pressing the stack between heated pressing elements. When using this technique, uneven pressing surfaces of the pressing elements, uneven distributions of material (e.g., fibers and matrix material) within the laminae, and/or the like can cause an uneven distribution of pressure between the stack and the pressing elements. Furthermore, gas pockets can be trapped between the stack and the pressing elements, between the laminae, and/or within the laminae. Such uneven distribution of pressure and/or gas pockets can result in the produced laminate having uneven distributions of material, unpredictable structural characteristics, an uneven surface finish, and/or the like.

### SUMMARY

Some of the present tools are configured to, during pressing of a stack of one or more laminae between pressing elements, encourage an even application of pressure between the pressing elements and the stack by, for example, including first and second plates that are disposable on opposing sides of the stack, where at least one of the plates includes one or more resilient layers that can deform to compensate for irregularities on and/or unevenness of pressing surfaces of the pressing elements, uneven distributions of material within the lamina(e), and/or the like.

Some of the present tools are configured to, during pressing of a stack of one or more laminae between pressing elements, reduce (in number and/or size) gas pockets between the stack and the pressing elements, between the lamina(e), and/or within the lamina(e), by, for example, including first and second plates that are disposable on opposing sides of the stack to define an interior volume between the plates containing the stack, where at least a portion of the interior volume is sealable such that pressure within that portion can be reduced (e.g., via fluid communication with a vacuum source). Such a configuration can also encourage contact between the plates and the stack, facilitating metal layer(s) and/or resilient layer(s) of the plates—if present—in performing their functions, positioning of the stack relative to the plates, and/or the like.

In some of the present tools, at least one of the plates includes a metal layer, which can provide support for any resilient layer(s) of the plate, facilitate transfer of heat through the plate between the stack and the pressing elements, facilitate transportation of the stack (e.g., to and from the pressing elements), and/or the like.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially” and “approximately” may be substituted with “within [a percentage] of” what is specified, where the percentage includes 0.1, 1, 5, and 10 percent.

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, an apparatus that “comprises,” “has,” “includes,” or “contains” one or more elements possesses those one or more elements, but is not limited to possessing only those one or more elements. Likewise, a method that “comprises,” “has,” “includes,” or “contains” one or more steps possesses those one or more steps, but is not limited to possessing only those one or more steps.

Any embodiment of any of the apparatuses, systems, and methods can consist of or consist essentially of—rather than comprise/have/include/contain—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments are described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 depicts a first embodiment of the present tools, including first and second plates, the tool shown disposed between pressing elements of a press with its plates disposed on opposing sides of a stack of one or more laminae.

FIGS. 2A and 2B are side and top views, respectively, of the tool of FIG. 1.

FIGS. 3A-3C are top, bottom, and side views, respectively, of the first plate of the tool of FIG. 1.

FIG. 3D is a cross-sectional side view of the first plate of the tool of FIG. 1, taken along line 3D-3D of FIG. 3B.

FIG. 4 is a top view of a resilient layer that may be included in plate(s) of some of the present tools.

FIGS. 5A-5E depict seals that may be included in some of the present tools.

FIG. 6A is a cross-sectional side view, taken along line 6A-6A of FIG. 2B, of a port that may be included in some of the present tools, the port shown in a closed position.

FIG. 6B is a cross-sectional side view of the port of FIG. 6A shown in an open position.

FIG. 7 is a cross-sectional side view of a tab that may be included in plate(s) of some of the present tools.

FIG. 8 is an exploded view of a stack of one or more laminae that can be pressed using some of the present tools.

FIG. 9 depicts a lamina that may be included in a stack of one or more laminae.

FIG. 10 depicts a second embodiment of the present tools.

FIG. 11 is a side view of the tool of FIG. 10.

FIG. 12 depicts a plate that may be included in some of the present tools.

### DETAILED DESCRIPTION

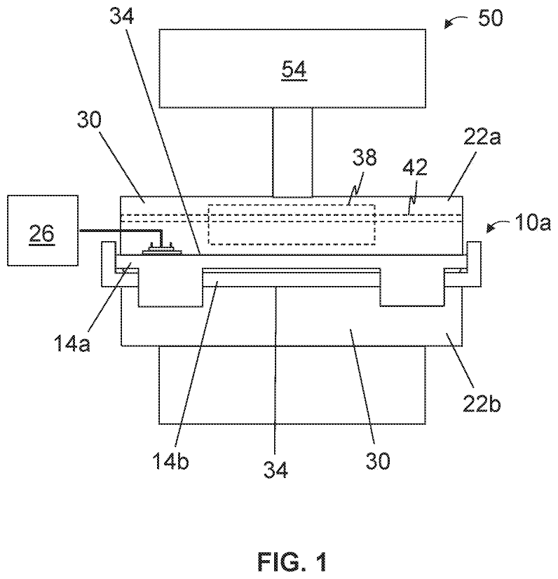

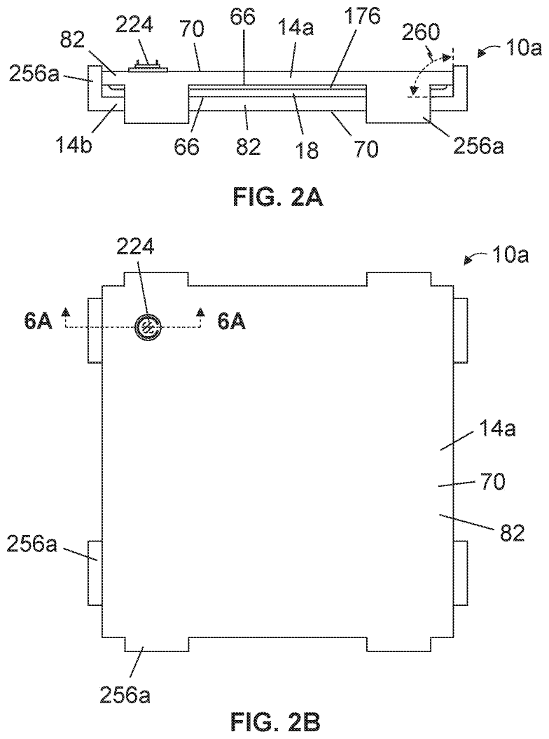

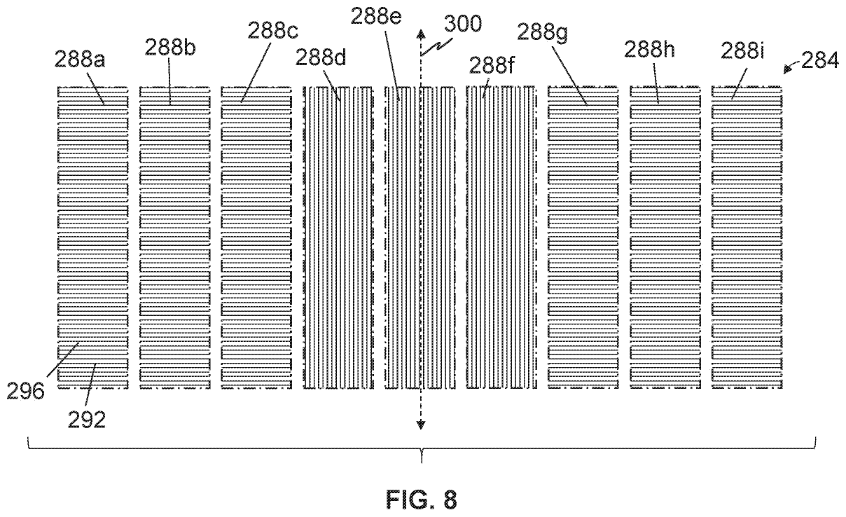

FIGS. 1, 2A, and 2B depict a first embodiment 10a of the present tools for use in pressing a stack of one or more laminae (e.g., 284, FIG. 8) during, for example, heating, cooling, and/or consolidation of the stack. Tool 10a can include a first plate 14a and a second plate 14b that are disposable on opposing sides of the stack such that, when the stack is pressed between pressing elements (e.g., 22a and 22b), the plates define the interface between the stack and the pressing elements. At least a portion (e.g., 180, described below) of an interior volume 18 (FIG. 2A) defined between the plates that contains the stack can be sealable such that pressure within that portion can be reduced using, for example, a vacuum source (e.g., 26) (e.g., a pump) in fluid communication with that portion. As described below, in at least these ways, tool 10a can facilitate heating, consolidation, and/or cooling of the stack and/or transportation of the stack (e.g., to and from the pressing elements).

Pressing elements (e.g., 22a and 22b) usable with the present tools (e.g., 10a) can each can comprise any suitable pressing element, such as, for example, a platen, plate, block, belt, and/or the like, and can be characterized generally as having a body (e.g., 30) defining a pressing surface (e.g., 34), whether planar, concave, and/or convex, that is configured to contact an object when the object is pressed by the pressing element. At least one of the pressing elements can have a variable temperature via, for example, including one or more electric heating elements (e.g., 38), one or more interior passageways (e.g., 42) through which a heating and/or cooling fluid (e.g., water, steam, a thermal fluid, and/or the like) can be passed, and/or the like. As shown in FIG. 1, the pressing elements can be components of a press 50. To illustrate, press 50 can include one or more actuators 54, each coupled to at least one of the pressing elements, where the actuator(s) are configured to move the pressing elements relative to one another to press an object between the pressing elements. Actuator(s) 54 can include any suitable actuator, such as, for example, a hydraulic, electric, and/or pneumatic actuator.

Each of plates 14a and 14b has an inner face 66 and an opposing outer face 70. When plates 14a and 14b are disposed on opposing sides of a stack of one or more laminae (e.g., 284), inner faces 66 face the stack to define interior volume 18. To illustrate, interior volume 18 is a volume existing between inner faces 66 of plates 14a and 14b—which can be created by the presence of the stack and/or one or more seals 176 (described below) between the plates—that is not occupied by either of the plates, notwithstanding the presence of other structures within the volume, such as the stack and the seal(s). Interior volume 18 can be, but need not be, bounded on its sides by plate 14a and/or 14b. When plates 14a and 14b are disposed between pressing elements (e.g., 22a and 22b), outer faces 70 face the pressing elements.

In tool 10a, inner faces 66 of plates 14a and 14b are planar when the plates are in an unflexed state; for example, the plates may flex when a stack of one or more laminae (e.g., 284) is disposed between the plates, when the plates are pressed between pressing elements (e.g., 22a and 22b), and/or as pressure within interior volume 18 is reduced. In other tools, at least one plate can include an inner face having non-planar portions, such as, for example, curved (e.g., concave and/or convex) portions. When a stack of one or more laminae (e.g., 284) is pressed between plates, the stack can assume a shape that corresponds to inner faces of the plates; thus, at least by selecting the geometry of the inner faces, a desired shape for a laminate can be achieved. In some tools (e.g., 10a), outer faces (e.g., 70) of plates (e.g., 14a and 14b) can be planar (when the plates are in an unflexed state), which can facilitate use of the tool with pressing elements (e.g., 22a and 22b) having planar pressing surfaces (e.g., 34).

Each of plates 14a and 14b can include one or more layers that aid in heating, cooling, and/or consolidation of a stack of one or more laminae (e.g., 284) using a set of pressing elements (e.g., 22a and 22b). Such layers can include, for example, thermally-conductive layer(s), which may facilitate transfer of heat between the pressing element(s) and the stack, and/or resilient layer(s), which may encourage an even application of pressure to the stack by the pressing elements. A plate (e.g., 14a and/or 14b), depending on its layer(s), may or may not be rigid.

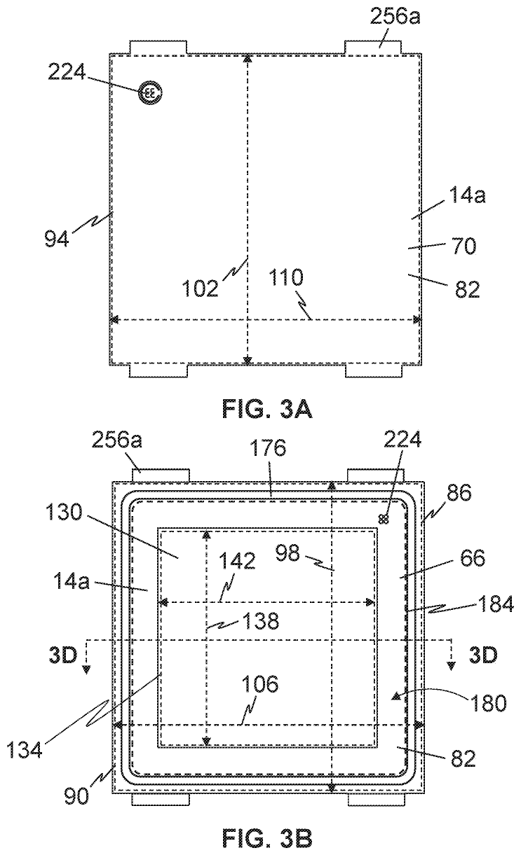

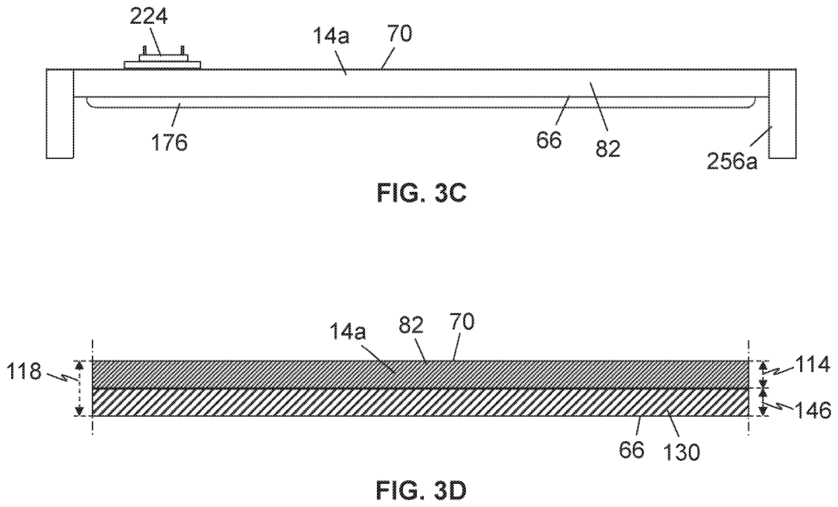

For example, and referring additionally to FIGS. 3A-3D, shown is plate 14a. Plate 14a is shown and discussed by way of illustration, and plate 14b can include any of the features described below with respect to plate 14a. Plate 14a can include a metal layer 82. Metal layer 82 can define and/or underlie at least a majority of inner face 66 and/or outer face 70 of plate 14a. For example, an area 86 spanned by (e.g., between edges of) a largest face of metal layer 82, including portions of the face covered by other portions of plate 14a, such as one or more resilient layers (e.g., 130, described below), can be equal to more than half of (e.g., up to and including all of) an area 90 spanned by inner face 66 and/or an area 94 spanned by outer face 70. For further example, metal layer 82 can have a length 98 that is greater than or substantially equal to any one of, or between any two of: 55, 60, 65, 70, 75, 80, 85, 90, 95, or 100% of a length 102 of plate 14a and/or a width 106 that is greater than or substantially equal to any one of, or between any two of: 55, 60, 65, 70, 75, 80, 85, 90, 95, or 100% of a width 110 of the plate. Some tools can include a plate having a metal layer that defines and/or underlies less than a majority of an inner face and/or an outer face of the plate.

A thickness 114 of metal layer 82 can be less than or substantially equal to any one of, or between any two of: 5, 10, 15, 20, 25, 30, 35, 40, 45, 50, 55, 60, 65, 70, 75, 80, 85, 90, 95, or 100% of a thickness (e.g., 118, FIG. 3D) of plate 14a, measured through the metal layer. For example, thickness 114 of metal layer 82 can be less than or substantially equal to any one of, or between any two of: 0.25, 0.30, 0.35, 0.40, 0.45, 0.50, 0.55, 0.60, 0.65, 0.70, 0.75, 0.80, 0.85, 0.90, 0.95, 1.00, 1.10, 1.20, 1.30, 1.40, 1.50, 1.60, 1.70, 1.80, 1.90, 2.00, 2.50, or 3.00 millimeters (mm) (e.g., approximately 0.50 mm, less than approximately 2.00 mm, and/or the like).

Metal layer 82 can comprise any suitable metal, and such a metal may be thermally-conductive. For example, in plate 14a, metal layer 82 can comprise stainless steel. In other plates, a metal layer can comprise this and/or any other suitable metal, such as, for example, copper, aluminum, brass, steel, bronze, an alloy thereof, and/or the like. A metal layer (e.g., 82) including a thermally-conductive metal can increase a plate's ability to transfer heat between a stack of one or more laminae (e.g., 284) and a pressing element (e.g., 22a or 22b), and such functionality can be enhanced by the metal layer having a relatively small thickness (e.g., 114). A metal layer (e.g., 82) can add rigidity to a plate (e.g., 14a), which can facilitate transportation of the plate (e.g., to and from pressing elements 22a and 22b), provide support for a stack of one or more laminae (e.g., 284) disposed on the plate, provide support for resilient layer(s) (e.g., 130, described below) of the plate, and/or the like. Some tools can include plate(s) that do not have such a metal layer (e.g., 82).

Plate 14a can include a resilient layer 130. In this embodiment, resilient layer 130 defines at least a portion of inner face 66 of plate 14a such that, for example, the resilient layer contacts a stack of one or more laminae (e.g., 284) when the stack is pressed by the plate. Some tools can include at least one plate having a resilient layer that defines at least a portion of an outer face of the plate such that, for example, the resilient layer contacts a pressing element (e.g., 22a or 22b) when the plate is used to press a stack of one or more laminae (e.g., 284) using the pressing element.

An area 134 spanned by a largest face of resilient layer 130 can be greater than or substantially equal to any one of, or between any two of: 20, 25, 30, 35, 40, 45, 50, 55, 60, 65, 70, 75, 80, 85, 90, 95, or 100% of area 90 and/or area 94. Resilient layer 130 can have a length 138 that is greater than or substantially equal to any one of, or between any two of: 20, 25, 30, 35, 40, 45, 50, 55, 60, 65, 70, 75, 80, 85, 90, 95, or 100% of length 102 and/or a width 142 that is greater than or substantially equal to any one of, or between any two of: 20, 25, 30, 35, 40, 45, 50, 55, 60, 65, 70, 75, 80, 85, 90, 95, or 100% of width 110.

A thickness 146 of resilient layer 130 can be less than or substantially equal to any one of, or between any two of: 5, 10, 15, 20, 25, 30, 35, 40, 45, 50, 55, 60, 65, 70, 75, 80, 85, 90, 95, or 100% of a thickness (e.g., 118) of plate 14a, measured through the resilient layer. For example, thickness 146 of resilient layer 130 can be less than or substantially equal to any one of, or between any two of: 0.05, 0.10, 0.15, 0.20, 0.25, 0.30, 0.35, 0.40, 0.45, 0.50, 0.55, 0.60, 0.65, 0.70, 0.75, 0.80, 0.85, 0.90, 1.00, 1.10, 1.20, 1.30, 1.40, 1.50, 1.60, 1.70, 1.80, 1.90, 2.00, 2.50, or 3.00 mm (e.g., approximately 0.13, 0.15, 0.25, or 0.50 mm).

In plate 14a, resilient layer 130 comprises polytetrafluoroethylene; in other plates, a resilient layer can comprise this or any other suitable resilient material, such as, for example, silicon, silicone, Kapton, an elastomer, a gasket material, and/or the like. In some tools (e.g., 10a), at least one plate (e.g., 14a and/or 14b) includes a resilient layer (e.g., 130) comprising a material selected to prevent the resilient layer from bonding to a stack of one or more laminae (e.g., 284), a pressing element (e.g., 22a and/or 22b), and/or other resilient layer(s) of the plate. For example, the resilient layer can comprise a material having a glass transition temperature that is higher than a glass transition temperature of a matrix material (e.g., 296, described below) of the stack.

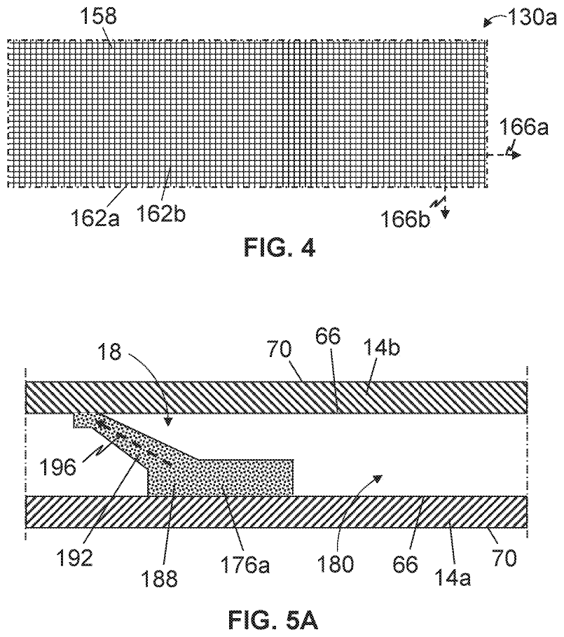

FIG. 4 depicts a resilient layer 130a that may be included in plate(s) (e.g., 14a and/or 14b, as resilient layer 130) of some of the present tools (e.g., 10a). Resilient layer 130a includes fibers 158 dispersed within the resilient material of the layer. Fibers 158 of resilient layer 130a can be arranged in a woven configuration; for example, the resilient layer can include a first set of fibers 162a aligned with a first direction 166a and a second set of fibers 162b aligned with a second direction 166b that is angularly disposed (e.g., at an angle of approximately 90 degrees) relative to the first direction, where the first set of fibers is woven with the second set of fibers. As used herein, “aligned with” means within 10 degrees of parallel to. In resilient layer 130a, fibers 158 comprise glass fibers; in other resilient layers, fibers can comprise these and/or any other suitable fibers, such as, for example, carbon fibers, aramid fibers, polyethylene fibers, polyester fibers, polyamide fibers, ceramic fibers, basalt fibers, steel fibers, and/or the like. In some resilient layers, fibers can be arranged in a non-woven configuration; for example, the fibers can be arranged such that substantially all of the fibers are aligned in a single direction, the fibers can comprise discontinuous or short fibers, and/or the like.

Some tools can have at least one plate including a resilient layer having fibers that form a cloth (woven or nonwoven), whether or not those fibers are dispersed within a resilient material as described above with respect to FIG. 4. Such a cloth can include, for example, a glass fiber mat, a layer of asbestos, a polyester fabric, a breather cloth, and/or the like.

In the present tools (e.g., 10a), as pressure is reduced within a portion of an interior volume (e.g., 18) that contains a stack of one or more laminae (e.g., 284), a resilient layer (e.g., 130) of a plate (e.g., 14a and/or 14b) can provide a path for gas, such as gas pockets that may be located between the stack and the plate, between the lamina(e), and/or within the lamina(e), to exit the portion of the interior volume, deform to contact the stack, thereby enhancing operation of the resilient layer, other resilient layer(s), metal layer(s) (e.g., 82), and/or the like of the plate, and/or the like. Such a resilient layer (e.g., 130) can increase a plate's (e.g., 14a) ability to encourage an even application of pressure between pressing elements (e.g., 22a and 22b) and a stack of one or more laminae (e.g., 284) by, for example, deforming to compensate for irregularities on and/or unevenness of pressing surface(s) (e.g., 34) of the pressing elements, variations in the thickness of the stack, and/or the like. Some tools can include plate(s) that do not have such a resilient layer (e.g., 130).

In plates (e.g., 14a and/or 14b) having more than one layer (e.g., a metal layer 82 and a resilient layer 130), the layers can be coupled to one another in any suitable fashion, including, for example, by bonding (e.g., by welding, application of heat and pressure, adhesive, and/or the like), placing one(s) of the layers in contact with other(s) of the layers, interlocking features of the layers, through use of fastener(s) (e.g., screw(s), bolt(s), rivet(s), pin(s), and/or the like), and/or the like. In some such plates, at least one of the layers is removable from at least one other of the layers.

The present tools (e.g., 10a) can include at least one plate (e.g., 14a and/or 14b) that has a thickness (e.g., 118), measured through each of the plate's layers (e.g., metal layer 82 and resilient layer 130), that is less than or substantially equal to any one of, or between any two of: 0.40, 0.45, 0.50, 0.55, 0.60, 0.65, 0.70, 0.75, 0.80, 0.85, 0.90, 1.00, 1.10, 1.20, 1.30, 1.40, 1.50, 1.60, 1.70, 1.80, 1.90, 2.00, 2.10, 2.20, 2.30, 2.40, 2.50, 3.00, 3.50, 4.00, 4.50, 5.00, 5.50, 6.00, 7.00, 8.00, 9.00, or 10.00 mm (e.g., less than approximately 6 mm). In general, a thinner plate may be more effective than a thicker plate at transferring heat between a pressing element (e.g., 22a or 22b) and a stack of one or more laminae (e.g., 284).

Tool 10a and its plates 14a and 14b are provided by way of example, as the present tools can include plates that each have any suitable number of metal layer(s) (e.g., 82) (e.g., 0, 1, 2, 3, or more metal layer(s)) and resilient layer(s) (e.g., 130) (e.g., 0, 1, 2, 3, 4, 5, 6, 7, 8, 9, 10, or more resilient layer(s)), and such layer(s) can be arranged in any suitable order (e.g., with one of the metal layer(s) or resilient layer(s) defining at least a portion of an inner face of the plate, one of the metal layer(s) or resilient layer(s) defining at least a portion of an outer face of the plate, and/or the like). In plates having two or more metal layers (e.g., 82) and/or two or more resilient layers (e.g., 130), the metal layers can, but need not, comprise the same material and/or have the same thickness (e.g., 114), and the resilient layers can, but need not, comprise the same material and/or have the same thickness (e.g., 146).

Some tools include at least one plate that can be characterized as having a first layer (e.g., a metal layer 82), at least a majority of which (e.g., by volume and/or weight) comprises a first material, and a second layer (e.g., a resilient layer 130), at least a majority of which (e.g., by volume and/or weight) comprises a second material that is distinct from the first material, where the first material can have a higher stiffness, higher hardness, and/or the like than the second material. In such tools, the first material can be non-polymeric, and the second material can be polymeric. In such tools, the first layer can be gas-impermeable, and the second layer can be gas-permeable.

Tool 10a can include one or more seals 176 disposable between plates 14a and 14b such that the one or more seals surround at least a portion 180 (location relative to plate 14a indicated in FIG. 3B) of interior volume 18. More particularly, seal(s) 176 can surround portion 180 of interior volume 18 such that pressure within that portion can be reduced relative to pressure outside of that portion (e.g., pressure outside of plates 14a and 14b, atmospheric pressure, and/or the like). An area 184 spanned by portion 180 of interior volume 18 along plate 14a can be equal to more than half of area 90 (e.g., 55, 60, 65, 70, 75, 80, 85, 90, 95, or 100% of area 90).

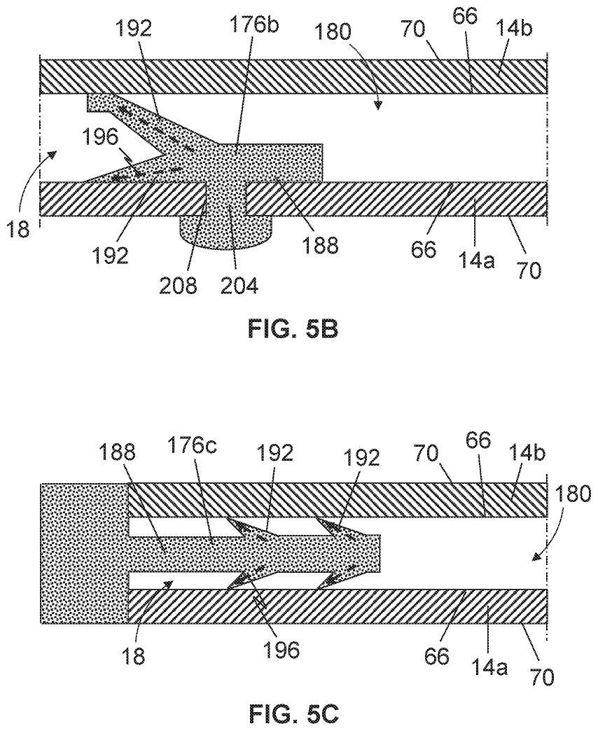

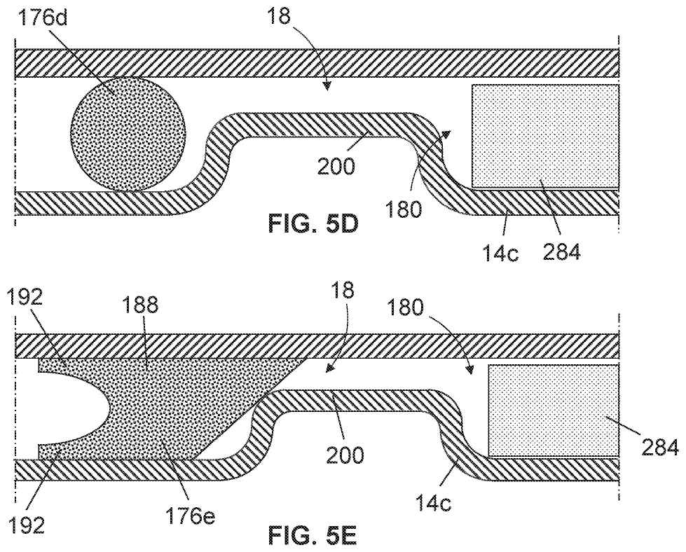

Seal(s) 176 can comprise any suitable seal; for example, FIGS. 5A-5C depict exemplary seals 176a-176c, each of which may be suitable for use as a seal 176. Seals 176a-176c can each include a body 188 and one or more ribs 192 that extend outwardly from the body. More particularly, each of ribs(s) 192 can extend from body 188 in a direction 196 away from portion 180 of interior volume 18 and contact one of plates 14a and 14b. In this way, as pressure within portion 180 of interior volume 18 is reduced relative to pressure outside of that portion, each of rib(s) 192 can be urged toward one of plates 14a and 14b, thereby facilitating a seal between the rib and the plate. Body 188 and rib(s) 192 can extend along a periphery of portion 180 of interior volume 18. Other examples of seals suitable for use in the present tools include a sealant (e.g., which can be disposed on at least one of the plates in the form of a bead), a sealing tape (e.g., including adhesive on one or both of its sides for bonding the tape to the plate(s)), an O-ring (e.g., which can be located relative to at least one of the plates by abutting a ridge of or being disposed within a recess of the plate), a gasket, and/or the like.

Referring additionally to FIGS. 5D and 5E, in some tools, at least one of the plates (e.g., plate 14c) defines a ridge 200, and, when one or more seals (e.g., one or more of 176d, 176e, and/or any seal described above) are disposed between the plates, the ridge is disposed between at least one of the seal(s) and portion 180 of interior volume 18. In this way, ridge 200 can restrict movement of the at least one seal into portion 180 of interior volume 18 as pressure within that portion is reduced relative to pressure outside of that portion. As shown, ridge 200 can also facilitate locating of a stack of one or more laminae (e.g., 284) relative to the plates.

Seal(s) (e.g., one or more of any seal described above) of a tool (e.g., 10a) can be coupled to plates (e.g., 14a and 14b) of the tool in any suitable fashion. As shown in FIG. 5A, at least one of the seal(s) can be bonded (e.g., by welding, application of heat and pressure, adhesive, and/or the like) to one of the plates. As shown in FIG. 5B, at least one of the seal(s) can be coupled to one of the plates via interlocking features of the seal and the plate; for example, one of the seal and the plate can include a projection 204 that is receivable by an opening 208 of the other of the seal and the plate to couple the seal to the plate. As shown in FIG. 5C, at least one of the seal(s) can be coupled to an edge of at least one of the plates such that the edge restricts movement of the seal into portion 180 of interior volume 18 as pressure within that portion is reduced relative to pressure outside of that portion. In some tools, at least one of the seal(s) can be coupled to one of the plates using one or more fasteners (e.g., screw(s), bolt(s), rivet(s), pin(s), and/or the like). In some tools, at least one of the seal(s) can be integrally formed with one of the plates (e.g., with a resilient layer 130 or a metal layer 82 thereof). Seal(s) (e.g., one or more of any seal described above) of a tool (e.g., 10a) can comprise any suitable material, such as, for example, polytetrafluoroethylene, silicon, silicone, Kapton, an elastomer, a gasket material, and/or the like.

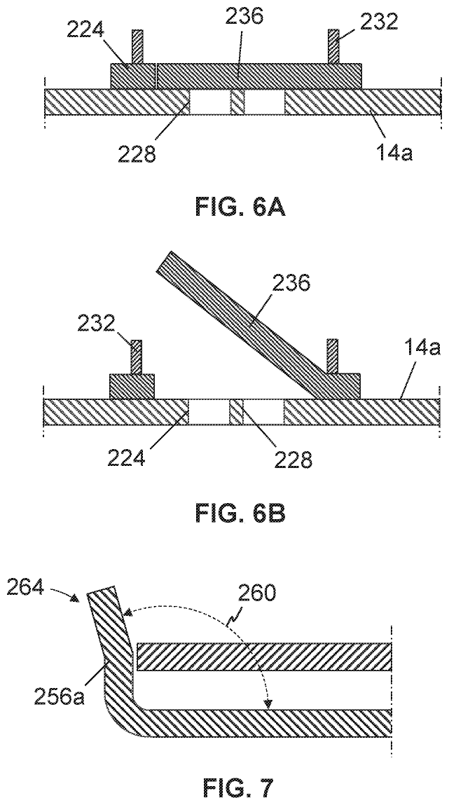

Referring additionally to FIGS. 6A and 6B, tool 10a can include a port (e.g., 224) for permitting fluid communication between portion 180 of interior volume 18 and a vacuum source (e.g., 26, FIG. 1). Port 224 is provided by way of illustration, as the present tools (e.g., 10a) can include any suitable port. Port 224 can include one or more openings 228 in fluid communication with portion 180 of interior volume 18. For example, opening(s) 228 can extend through one of plates 14a and 14b (e.g., plate 14a, as shown). Port 224 can include a connector 232 that is couplable to the vacuum source to permit fluid communication, via opening(s) 228, between the vacuum source and portion 180 of interior volume 18.

Port 224 can include a flap 236 that is movable between a closed position (FIG. 6A), in which the flap blocks fluid communication through opening(s) 228, and an open position (FIG. 6B), in which the flap permits fluid communication through opening(s) 228. Movement of flap 236 between the closed position and the open position can be responsive to differences between pressure acting on a first side of the flap that faces opening(s) 228 (e.g., pressure within portion 180 of interior volume 18) and pressure acting on a second side of the flap that is opposite the first side (e.g., pressure supplied by vacuum source 26). To illustrate, when pressure acting on the first side of flap 236 is less than pressure acting on the second side of the flap, the flap can be urged toward the closed position (e.g., to prevent an increase in pressure within portion 180 of interior volume 18), and, when pressure acting on the first side of the flap is greater than pressure acting on the second side of the flap, the flap can be urged toward the open position (e.g., to permit a decrease in pressure within portion 180 of interior volume 18). While port 224 of tool 10a is coupled to first plate 14a, in other tools, a port can be coupled to a first plate, second plate, and/or at least one seal of the tool.

Tool 10a can include, for at least one of plates 14a and 14b, one or more tabs 256a coupled to and extending from the plate. Tab(s) 256a can facilitate positioning of plates 14a and 14b relative to one another. For example, at least one of tab(s) 256a can be angularly disposed relative to its respective plate; to illustrate, an angle 260 (FIG. 2A) between at least a portion of the tab and its respective plate can be less than or substantially equal to any one of, or between any two of: 90, 95, 100, 105, 110, 115, 120, 125, 130, 135, 140, 145, 150, 155, or 160 degrees. In this way, when plates 14a and 14b are coupled together, tab(s) 256a coupled to one of the plates can engage the other of the plates, thereby positioning the plates relative to one another. In tool 10a, tab(s) 256a are unitary with their respective plates (e.g., metal layers 82 thereof); however, in other tools, tab(s) (e.g., 256a) can be coupled to plate(s) of the tool in any suitable fashion, such as, for example, via one or more fasteners (e.g., screw(s), bolt(s), rivet(s), pin(s), and/or the like), adhesive, and/or the like.

Referring additionally to FIG. 7, in some tools, at least one tab (e.g., 256a) can include an end 264, opposite its respective plate, that is angularly disposed at a greater than 90 degree angle 260 relative to its respective plate. Such a tab can facilitate coupling of its respective plate to the other plate by, for example, permitting a degree of misalignment between the plates during coupling of the plates.

Provided by way of example, FIG. 8 depicts a stack of one or more laminae 284 that can be pre-heated, consolidated, and/or cooled using embodiments of the present tools. Stack 284 includes nine laminae, 288a-288i; however, stacks of one or more laminae usable with the present tools can include any suitable number of lamina(e), such as, for example, 1, 2, 3, 4, 5, 6, 7, 8, 9, 10, 11, 12, 13, 14, 15, or more lamina(e).

In stack 284, each of laminae 288a-288i includes fibers 292 dispersed within a matrix material 296. Fibers (e.g., 292) of a lamina (e.g., any of laminae 288a-288i) can include any suitable fibers, such as, for example, any of the fibers described above. A matrix material (e.g., 296) of a lamina (e.g., any of laminae 288a-288i) can include any suitable matrix material, such as, for example, a thermoplastic or thermoset matrix material. A suitable thermoplastic matrix material can include, for example, polyethylene terephthalate, polycarbonate (PC), polybutylene terephthalate (PBT), poly(1,4-cyclohexylidene cyclohexane-1,4-dicarboxylate) (PCCD), glycol-modified polycyclohexyl terephthalate (PCTG), poly(phenylene oxide) (PPO), polypropylene (PP), polyethylene (PE), polyvinyl chloride (PVC), polystyrene (PS), polymethyl methacrylate (PMMA), polyethyleneimine or polyetherimide (PEI) or a derivative thereof, a thermoplastic elastomer (TPE), a terephthalic acid (TPA) elastomer, poly(cyclohexanedimethylene terephthalate) (PCT), polyethylene naphthalate (PEN), a polyamide (PA), polystyrene sulfonate (PSS), polyether ether ketone (PEEK), polyether ketone ketone (PEKK), acrylonitrile butyldiene styrene (ABS), polyphenylene sulfide (PPS), a copolymer thereof, or a blend thereof. A suitable thermoset matrix material can include, for example, an unsaturated polyester resin, a polyurethane, bakelite, duroplast, urea-formaldehyde, diallyl-phthalate, epoxy resin, an epoxy vinylester, a polyimide, a cyanate ester of a polycyanurate, dicyclopentadiene, a phenolic, a benzoxazine, a co-polymer thereof, or a blend thereof. To illustrate, a lamina (e.g., any of laminae 288a-288i) including fibers (e.g., 292) can have a pre-consolidation fiber volume fraction that is greater than or substantially equal to any one of, or between any two of: 40, 45, 50, 55, 60, 65, 70, 75, 80, 85, or 90%.

In stack 284, each of laminae 288a-288i is a unidirectional lamina, or a lamina having fibers 292, substantially all of which are aligned with a single direction. More particularly, in each of the laminae, the fibers are either aligned with a long dimension of the stack (e.g., measured in direction 300) (e.g., laminae 288d-288f, each of which may be characterized as a 0-degree unidirectional lamina) or are aligned with a direction that is perpendicular to the long dimension of the stack (e.g., laminae 288a-288c and laminae 288g-288i, each of which may be characterized as a 90-degree unidirectional lamina). Some stacks can include unidirectional lamina(e) that each have fibers (e.g., 292) that are aligned with any suitable direction, such as, for example, a direction that is angularly disposed relative to a long dimension of the stack at an angle that is greater than or substantially equal to any one of, or between any two of: 0, 5, 10, 15, 20, 25, 30, 35, 40, 45, 50, 55, 60, 65, 70, 75, 80, 85, or 90 degrees.

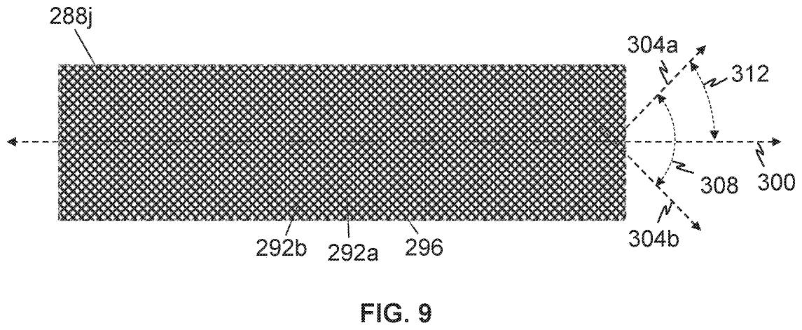

Some stacks can include lamina(e) having fibers (e.g., 292) arranged in a woven configuration (e.g., as in a lamina having a plane, twill, satin, basket, leno, mock leno, or the like weave). Referring additionally to FIG. 9, lamina 288j, which can be included in a stack, can include a first set of fibers 292a aligned with a first direction 304a and a second set of fibers 292b aligned with a second direction 304b that is angularly disposed relative to the first direction, where the first set of fibers is woven with the second set of fibers. A smallest angle 308 between first direction 304a and second direction 304b can be greater than or substantially equal to any one of, or between any two of: 5, 10, 15, 20, 25, 30, 35, 40, 45, 50, 55, 60, 65, 70, 75, 80, 85, or 90 degrees. A smallest angle 312 between first direction 304a and a long dimension of a stack including lamina 288j (e.g., measured in direction 300) can be greater than or substantially equal to any one of, or between any two of: 0, 5, 10, 15, 20, 25, 30, 35, 40, 45, 50, 55, 60, 65, 70, 75, 80, 85, or 90 degrees.

In stack 284, laminae 288a-288i are arranged in a 90, 90, 90, 0, 0, 0, 90, 90, 90 lay-up. Other stacks can include any suitable lamina(e), including one or more of any lamina described above, arranged in any suitable lay-up, whether symmetric or asymmetric.

Some stacks of one or more laminae (e.g., 284) can include sheet(s), film(s), core(s) (e.g., porous, non-porous, honeycomb, and/or the like core(s)), and/or the like. Such sheet(s), film(s), and/or core(s) may or may not comprise fibers (e.g., 292) and can comprise any material described above as a matrix material (e.g., 296).

As described above, the present tools (e.g., 10a) can be configured to encourage an even application of pressure to a stack of one or more laminae (e.g., 284) by pressing elements (e.g., 22a and 22b). As effective pre-heating, consolidation, and/or cooling of thin stacks of one or more laminae may be particularly susceptible to uneven applications of such pressure, the present tools (e.g., 10a) may be suited for use in pre-heating, consolidating, and/or cooling of such thin stacks. For example, such a stack can have a pre-consolidation thickness, measured through each of its lamina(e), that is less than or substantially equal to any one of, or between any two of: 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 mm. For further example, lamina(e) of such a stack can each have a pre-consolidation thickness that is less than or substantially equal to any one of, or between any two of: 0.05, 0.10, 0.15, 0.20, 0.25, 0.30, 0.35, 0.40, 0.45, or 0.50 mm (e.g., between approximately 0.13 mm and approximately 0.16 mm). For yet further example, a laminate formed by consolidating such a stack can have a thickness that is less than or substantially equal to any one of, or between any two of: 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, or 2.5 mm (e.g., less than approximately 2.00, 1.75, 1.50, or 1.25 mm).

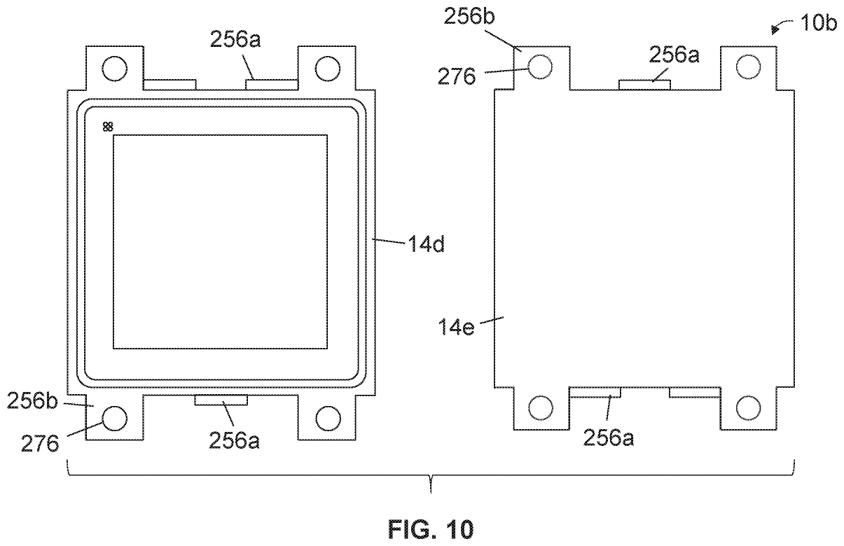

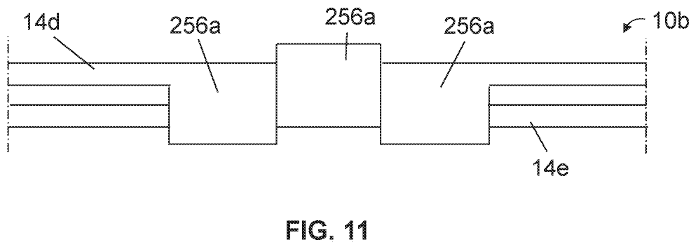

FIGS. 10 and 11 depict a second embodiment 10b of the present tools. Tool 10b can be substantially similar to tool 10a, with plates 14d and 14e being substantially similar to plates 14a and 14b, respectively, and the primary exceptions are described below. In tool 10b, one or more tabs 256a are coupled to plate 14d and one or more tabs 256a are coupled to plate 14e such that, when the plates are coupled to one another, the tab(s) coupled to plate 14d engage the tab(s) coupled to plate 14e (FIG. 11).

Tool 10b can include, for at least one of plates 14d and 14e, one or more tabs 256b coupled to and extending from the plate. At least one of tab(s) 256b can extend from its respective plate in a direction that is aligned with its respective plate. Such tab(s) 256b can function as handles for their respective plates, facilitating transportation of tool 10b and any stack of one or more laminae (e.g., 284) disposed within the tool (e.g., to and from pressing elements 22a and 22b). Tab(s) 256b can each define an opening 276, which can, for example, receive a locating pin of a pressing element (e.g., 22a or 22b), a pin, projection, or hook of a conveyor, an end effector, and/or the like.

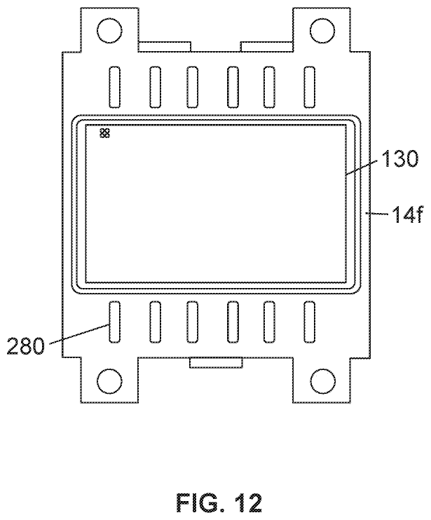

FIG. 12 depicts a plate 14f that may be suitable for use in some of the present tools. Plate 14f can be substantially similar to plate 14d, with the primary exception described below. During use, some portions of a plate, such as a center of the plate, may be exposed to higher temperatures than other portions of the plate, such as a periphery of the plate, and such uneven heating may cause distortion of the plate. To mitigate such distortion, plate 14f defines one or more openings 280 (e.g., through at least one of its layer(s)).

Some embodiments of the present methods for pressing a stack of one or more laminae comprise disposing a stack of one or more laminae (e.g., 284) between a first plate (e.g., any plate described above) and a second plate (e.g., any plate described above) such that an interior volume (e.g., 18) containing the stack is defined between the plates, forming a seal around at least a portion (e.g., 180) of the interior volume, reducing pressure within the interior volume, and pressing the stack by pressing the plates between pressing elements (e.g., 22a and 22b) of a press (e.g., 50). Reducing pressure within the interior volume can be performed before, during, and/or after pressing the stack. In some methods, at least one of the one or more laminae of the stack comprises fibers (e.g., 292) dispersed within a matrix material (e.g., 296).

In some methods, at least one of the plates comprises a metal layer (e.g., 82). In some methods, at least one of the plates comprises a resilient layer (e.g., 130 or 130a), and, optionally, the resilient layer comprises polytetrafluoroethylene, silicon, silicone, and/or Kapton. In some methods, the resilient layer defines at least a portion of an inner face (e.g., 66) of the plate that faces the stack.

In some methods, forming the seal is performed using one or more seals (e.g., one or more of any seal described above) that are disposed between the plates. In some methods, at least one of the one or more seals comprises a body (e.g., 188) and one or more ribs (e.g., 192) extending outwardly from the body, and forming the seal is performed such that each of the one or more ribs extends outwardly from the body in a direction (e.g., 196) away from the portion of the interior volume and is in contact with one of the plates. In some methods, at least one of the plates defines a ridge (e.g., 200), and forming the seal is performed such that the ridge is disposed between at least one of the one or more seals and the portion of the interior volume. In some methods, at least one of the one or more seals comprises a sealant. In some methods, at least one of the one or more seals is unitary with one of the plates.

In some methods that are otherwise similar to those described above, two or more stacks of laminae can be disposed between the first and second plates. In such methods, one or more resilient layers can be disposed between adjacent ones of the stacks; such resilient layer(s) can comprise any of the materials and/or features described above for resilient layer 130 and/or 130a.

Some tools for use in pressing a stack of one or more laminae comprise: first and second plates, wherein each of the plates has an inner face and an opposing outer face, and the first and second plates are configured to be disposed on opposing sides of a stack of one or more laminae such that the inner faces of the plates face the stack to define an interior volume containing the stack between the inner faces, one or more seals configured to be disposed between the plates such that the one or more seals surround at least a portion of the interior volume, and a port configured to be coupled to the first plate, the second plate, and/or at least one of the one or more seals, the port configured to permit fluid communication between the portion of the interior volume and a vacuum source.

In some tools, at least one of the plates comprises a metal layer. In some tools, at least one of the plates comprises a resilient layer, and, optionally, the resilient layer comprises polytetrafluoroethylene, silicon, and/or Kapton. In some tools, the resilient layer defines at least a portion of the inner face of the plate. In some tools, at least one of the plates has a thickness, measured between its inner face and its outer face, that is less than approximately 6 mm, and, optionally, the thickness is less than approximately 2 mm. Some tools comprise, for at least one of the plates, one or more tabs coupled to and extending from the plate.

In some tools, at least one of the one or more seals comprises a body and one or more ribs extending outwardly from the body, wherein, when the seal is disposed between the plates, each of the one or more ribs extends outwardly from the body in a direction away from the portion of the interior volume and is in contact with one of the plates. In some tools, the inner face of at least one of the plates defines a ridge, and, when the one or more seals are disposed between the plates, the ridge is disposed between at least one of the one or more seals and the portion of the interior volume. In some tools, at least one of the one or more seals comprises a sealant. In some tools, at least one of the one or more seals is unitary with one of the plates.

Some methods for pressing a stack of one or more laminae comprise: disposing a stack of one or more laminae between first and second plates such that an interior volume containing the stack is defined between the plates, forming a seal around at least a portion of the interior volume, reducing pressure within the interior volume, and pressing the stack by pressing the plates between pressing elements of a press. In some methods, at least one of the one or more laminae of the stack comprises fibers dispersed within a matrix material.

In some methods, at least one of the plates comprises a metal layer. In some methods, at least one of the plates comprises a resilient layer, and, optionally, the resilient layer comprises polytetrafluoroethylene, silicon, and/or Kapton. In some methods, the resilient layer defines at least a portion of an inner face of the plate that faces the stack.

In some methods, forming the seal is performed using one or more seals that are disposed between the plates. In some methods, at least one of the one or more seals comprises a body and one or more ribs extending outwardly from the body, and forming the seal is performed such that each of the one or more ribs extends outwardly from the body in a direction away from the portion of the interior volume and is in contact with one of the plates. In some methods, at least one of the plates defines a ridge, and forming the seal is performed such that the ridge is disposed between at least one of the one or more seals and the portion of the interior volume. In some methods, at least one of the one or more seals comprises a sealant. In some methods, at least one of the one or more seals is unitary with one of the plates.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A tool for use in pressing a stack of two or more laminae, the tool comprising:
first and second plates, wherein:
each of the plates has an inner face and an opposing outer face;
at least one of the plates comprises a first layer comprising a first material and a resilient second layer comprising a second material that is distinct from and has a lower stiffness than the first material; and
the first and second plates are configured to be disposed on opposing sides of a stack of two or more laminae such that the inner faces of the plates face the stack to define an interior volume containing the stack between the inner faces;
one or more seals configured to be disposed between the plates such that the one or more seals surround at least a portion of the interior volume; and
a port configured to be coupled to the first plate, the second plate, and/or at least one of the one or more seals, the port configured to permit fluid communication between the portion of the interior volume and a vacuum source.

2. The tool of claim 1, wherein at least one of the one or more seals comprises:
a body; and
one or more ribs extending outwardly from the body;
wherein, when the seal is disposed between the plates, each of the one or more ribs:
extends outwardly from the body in a direction away from the portion of the interior volume; and
is in contact with one of the plates.

3. The tool of claim 1, wherein:
the inner face of at least one of the plates defines a ridge; and
when the one or more seals are disposed between the plates, the ridge is disposed between at least one of the one or more seals and the portion of the interior volume.

4. The tool of claim 1, wherein at least one of the one or more seals comprises a sealant.

5. The tool of claim 1, wherein at least one of the one or more seals is unitary with one of the plates.

6. The tool of any of claims 1-5, wherein the first material comprises a metal.

7. The tool of any of claims 1-5, wherein the second material comprises polytetrafluoroethylene, silicon, and/or Kapton.

8. The tool of claim 7, wherein the resilient second layer defines at least a portion of the inner face of the plate.

9. The tool of any of claims 1-5, wherein:
at least one of the plates has a thickness, measured between its inner face and its outer face, that is less than approximately 6 millimeters (mm); and
optionally, the thickness is less than approximately 2 mm.

10. The tool of any of claims 1-5, comprising, for at least one of the plates, one or more tabs coupled to and extending from the plate.

11. A method for pressing a stack of two or more laminae, the method comprising:
disposing a stack of two or more laminae between first and second plates such that an interior volume containing the stack is defined between the plates, wherein at least one of the plates comprises a first layer comprising a first material and a resilient second layer comprising a second material that is distinct from and has a lower stiffness than the first material;
forming a seal around at least a portion of the interior volume that contains the stack;
reducing pressure within the portion of the interior volume; and
pressing the stack by pressing the plates between pressing elements of a press.

12. The method of claim 11, wherein forming the seal is performed using one or more seals that are disposed between the plates.

13. The method of claim 12, wherein:
at least one of the one or more seals comprises:
a body; and
one or more ribs extending outwardly from the body; and
forming the seal is performed such that each of the one or more ribs:
extends outwardly from the body in a direction away from the portion of the interior volume; and
is in contact with one of the plates.

14. The method of claim 12, wherein:
at least one of the plates defines a ridge; and
forming the seal is performed such that the ridge is disposed between at least one of the one or more seals and the portion of the interior volume.

15. The method of claim 12, wherein at least one of the one or more seals comprises a sealant.

16. The method of claim 12, wherein at least one of the one or more seals is unitary with one of the plates.

17. The method of any of claims 11-16, wherein the first material comprises a metal.

18. The method of any of claims 11-16, wherein the second material comprises polytetrafluoroethylene, silicon, and/or Kapton.

19. The method of claim 18, wherein the resilient second layer defines at least a portion of an inner face of the plate that faces the stack.

20. The method of any of claims 11-16, wherein at least one of the two or more laminae of the stack comprises fibers dispersed within a matrix material.
